(19) United States
(12) Patent Application Publication
(10) Pub. No.: US 2021/0037441 A1
(43) Pub. Date: Feb. 4, 2021

(54) LOCATION-BASED PERFORMANCE OFFLOADING IN A NETWORK

(71) Applicant: Charter Communications Operating, LLC, St. Louis, MO (US)

(72) Inventors: Saran Khalid, Denver, CO (US); Perwaiz Akhtar, Aurora, CO (US)

(21) Appl. No.: 16/690,476

(22) Filed: Nov. 21, 2019

Related U.S. Application Data
(60) Provisional application No. 62/922,221, filed on Jul. 29, 2019.

(51) Int. Cl. H04W 36/30; H04W 36/32; H04W 36/22; H04W 36/08; H04L 25/02; H04L 5/00; H04W 40/36; H04W 8/08

(52) U.S. Cl. CPC H04W 36/30; H04W 36/32; H04W 36/22; H04W 8/08; H04L 25/0226; H04L 5/0051; H04W 40/36; H04W 36/08

(57) ABSTRACT

A pathloss calculation machine (PCM) calculates a pathloss to a base station from a location of a user device, in contrast to conventional approaches which either examine a grid of user activity and generalize each grid element for pathloss, or simply distribute the user load based on which cell region the subscriber device resides. The location-based pathloss and use of corresponding models as described herein takes into account and allows recognition of geographic and man-made obstacles such as tall buildings to enter into the pathloss calculation. A mobility management entity (MME) makes handoff determinations based on pathloss and loading of respective base stations to ensure that users are served from base stations (macro or small cell) that offer the least pathloss/loading.

### RELATED APPLICATION

This application is related to and claims the benefit of earlier filed U.S. Provisional Patent Application Ser. No. 62/922,221 entitled “LOCATION-BASED PATHLOSS OFFLOADING IN A NETWORK,” filed on Jul. 29, 2019, the entire teachings of which are incorporated herein by this reference.

### BACKGROUND

Conventional wireless networks typically include one or more cells of wireless coverage, each supported by a wireless base station for providing wireless services. By arranging the wireless base stations at regularly spaced intervals, a coverage region of each base station is adjacent a coverage region of another base station, therefore providing a continuous coverage area from the aggregation of coverage areas emanating from each base station.

Wireless transmission mediums such as those promulgated by wireless protocols encounter similar physical limitations as other transmission mediums. For example, distance and interference, both from intervening objects and nearby frequencies, contribute to a signal degradation known as pathloss. Pathloss affects the effective bandwidth of wireless service to user equipment such as cellphones and similar mobile devices.

### BRIEF DESCRIPTION OF EMBODIMENTS

This disclosure includes the observation that wireless communication with mobile user equipment such as cellphones, laptops, tablets and other subscriber devices is transient and dynamic due to user mobility that changes the physical location of such device. Unfortunately, conventional approaches to mobile user device management dispose base stations, responsible for wirelessly connecting with the user devices, according to a predetermined expectation of demand and user presence. A surge or spike of a number of users in a particular location can tend to overwhelm a conventional base station and result in a degraded user experience for the users competing for wireless resources.

Embodiments herein provide novel ways of maintaining wireless services at an appropriate level by activating small cell base stations in areas of concentrated user activity, and offloading users from a base station serving a larger cell region to the small cell base station based on calculated performances (such as based on one or more parameters associated with a location such as pathlosses, data rate information, etc.) that determines which users are best served by the offload to a small cell for accommodating a localized cluster of user activity. Small cell base stations may be established to service a coverage region disposed within a coverage region of a large (macro) cell base station, and handoffs between the base station are managed to provide each user with an acceptable user experience.

A performance calculation machine (PCM) calculates a performance to a base station from a location of a user device, in contrast to conventional approaches which either examine a grid of user activity and generalize each grid element for performance, or simply distribute the user load based on which cell region the subscriber device resides. The location-based performance allows recognition of geographic and man-made obstacles such as tall buildings to enter into the performance calculation. A mobility management entity (MME) makes handoff determinations based on performance and loading of respective base stations to ensure that users are served from base stations (macro or small cell) that offer the best performance such as least pathloss.

For example, in one embodiment, a method of selecting a base station from a plurality of cells includes determining, for each of a plurality of candidate base stations, a respective expected link performance between the user equipment and a respective base station, and determining, for each of the plurality of candidate base stations, a loading factor indicative of a number of connections served by the base station relative to a capacity of the base station. A base station is selected, based on the performance and loading factor for each of the candidate base stations, for wireless connection to a subscriber device. Generally, this occurs between two base stations, one of which the subscriber device is already served by, and a decision made by the MME to effect a handoff to another base station based on performance improvement if one base station is found to provide a lower pathloss than another base station. Accordingly, embodiments herein include a location-based decision initiate a handoff a subscriber device to a small cell from evaluating information from a performance model/matrix populated via channel state information for subscriber devices near small cell base stations to determine which site (small or large cell base station) has a higher expected link performance (or lower pathloss) and therefore direct the subscriber device to connect to the suitable cell.

In other words, one embodiment herein includes creating a first performance model associated with a first base station and a second performance model for a second wireless station. The first performance model is generated based on prior history of pathlosses and/or link performance determined between the first wireless base station and user equipment at each of the different geographical locations supported by the first wireless base station. The second performance model is generated based on prior history of pathlosses and/or link performance determined between the second wireless base station and user equipment at each of the different geographical locations supported by the second wireless base station. To determine which of the first wireless base station and the second wireless base station provides a lower pathloss (or better performance), embodiments herein include: receiving location information indicating a location of user equipment in a network environment; using the first performance model, for the location of the user equipment, calculating a first wireless performance between the user equipment and the first wireless base station; using the second performance model, calculating a second wireless performance between the user equipment and a second wireless base station; determining which of the first wireless base station and the second wireless base station provides a better performance (such as lower pathloss); and controlling a handoff of the user equipment from the first wireless base station to the second wireless base station based at least in part on a comparison of the calculated first wireless performance (such as pathloss) and the calculated second wireless performance (such as pathloss).

In other words, if the first performance model indicates that a calculated performance for the location of the user equipment and the first wireless base station is substantially lower than a calculated performance for the location of the user equipment and the second wireless base station as calculated using the second performance model, embodiments herein including initiating a handoff of the user equipment from the first wireless base station to the second wireless base station.

Note that any of the resources as discussed herein can include one or more computerized devices, wireless access points, wireless base stations, mobile communication devices, servers, base stations, wireless communication equipment, communication management systems, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon. The instructions, when executed by computer processor hardware, cause the computer processor hardware (such as one or more co-located or disparately processor devices) to: receive location information indicating a location of user equipment in a network environment; calculate a first wireless performance (such as pathloss) between the user equipment and a first wireless base station; calculate a second wireless performance (such as pathloss) between the user equipment and a second wireless base station; and control a handoff of the user equipment from the first wireless base station to the second wireless base station based at least in part on a comparison of the calculated first wireless performance (such as pathloss) and the calculated second wireless performance (such as pathloss).

One embodiment includes a computer readable storage medium and/or system having instructions stored thereon. The instructions, when executed by computer processor hardware, cause the computer processor hardware (such as one or more co-located or disparately processor devices) to: produce a first performance model indicating an ability of a first wireless station to provide wireless coverage to user equipment at multiple different locations in a first region, the first region residing in a region of wireless coverage provided by a third wireless station; produce a second performance model indicating an ability of a second wireless station to provide wireless coverage to user equipment at multiple different locations in a second region, the second region residing in the region of wireless coverage provided by the third wireless station; and select activation of the first wireless station in lieu of selecting activation of the second wireless station based on the first performance model and the second performance model.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of supporting different wireless services. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example context diagram illustrating a wireless network environment according to embodiments herein;

FIG. 2 shows base station handoff considerations in the wireless network environment of FIG. 1;

FIG. 3 shows small and macro cells between which handoffs occur as in FIG. 2;

FIG. 4 is a block diagram of a wireless handoff system implementing the handoff as in FIG. 3;

FIG. 5 shows a message flow for a handoff in the system of FIG. 4;

FIG. 6 shows a grid subdivision of elements in a wireless coverage region in a small or macro cell as in FIG. 3; and

FIGS. 7 and 8 combine to form a flowchart of location and pathloss based handoffs in the environment of FIG. 1 according to embodiments herein.

FIG. 9 is an example diagram illustrating a network environment including a first base station operated by a first service provider and a second base station operated by a second service provider according to embodiments herein.

FIG. 10 is an example diagram illustrating management of one or more handoffs based on performance models according to embodiments herein.

FIG. 11 is an example diagram illustrating monitoring of different performances associated with different wireless base stations and initiating handoffs according to embodiments herein.

FIG. 12 is an example diagram illustrating management of handing off user equipment from a first wireless base station (operated by a first wireless network service provider) to a second wireless base station (operated by a second wireless network service provider) according to embodiments herein.

FIG. 13 is an example diagram illustrating adjusting a wireless coverage region supported by a small cell wireless base station according to embodiments herein.

FIG. 14 is an example diagram illustrating comparison of a small cell wireless base station coverage to a large cell wireless base station coverage according to embodiments herein.

FIG. 15 is an example diagram illustrating use of a respective small cell wireless base station and large cell wireless base station to provide wireless connectivity according to embodiments herein.

FIG. 16 is an example diagram illustrating example computer hardware and software operable to execute operations according to embodiments herein.

FIG. 17 is an example diagram illustrating a method according to embodiments herein.

FIG. 18 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

In accordance with general embodiments, a wireless network environment provides telecommunication services between users on a fee-for-services subscriber basis. Users employ user equipment such as a subscriber device having cellular capability and Internet connectivity. A typical subscriber device is a personal communications device referred to as a cellphone or smartphone (mobile communication device or user equipment), however modern implementations embed such communications ability in a myriad of computing devices such as laptop computers (laptops), tablet computers (tablets) as well as other devices, collectively referred to as a subscriber device with respect to configurations herein.

The configurations below depict a plurality of subscriber devices operating in the wireless network environment throughout which the telecommunication services are allocated to the subscriber devices by an arrangement of base stations in wireless communication with the subscriber devices. Due to the mobile nature of the subscriber devices, a geographic location of each subscriber device and adjacency of base stations makes the number of subscriber devices and distance to a base station significant factors in providing a suitable user experience for each subscriber device.

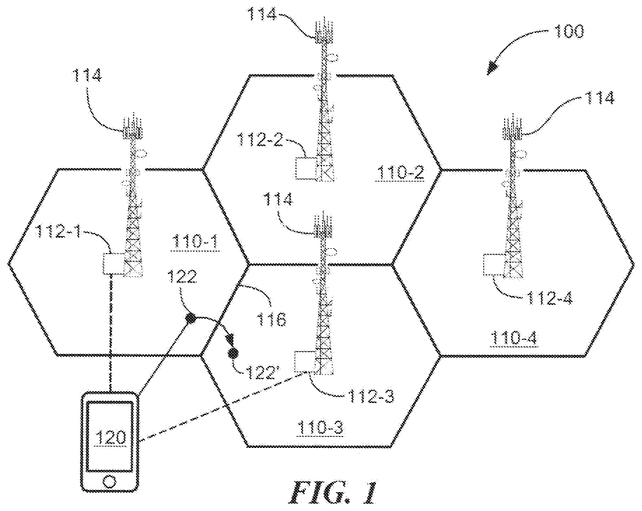

FIG. 1 is an example context diagram illustrating a wireless network environment according to embodiments herein. Referring to FIG. 1, in the wireless network environment 100, a plurality of macro cells 110-1 . . . 110-4 (110 generally) subdivide the geographic area, each served by a wireless base station 112-1 . . . 112-4 (base station, 112 generally). The base station 112 communicates with subscriber devices 120 in the macro cell 110 via an antenna 114 corresponding to the base station 112. A plurality of cells 110 is each defined by cell boundaries 116 generally demarcating the region within each macro cell 110.

Each subscriber device 120 disposed at a location 122 is served by (in communication with) the base station 112 of the macro cell 110 it occupies. When a subscriber device 120 is disposed to a new location 122′ by crossing the cell boundary 116, a handoff occurs to the base station 112 of the macro cell 110-N it has just moved into.

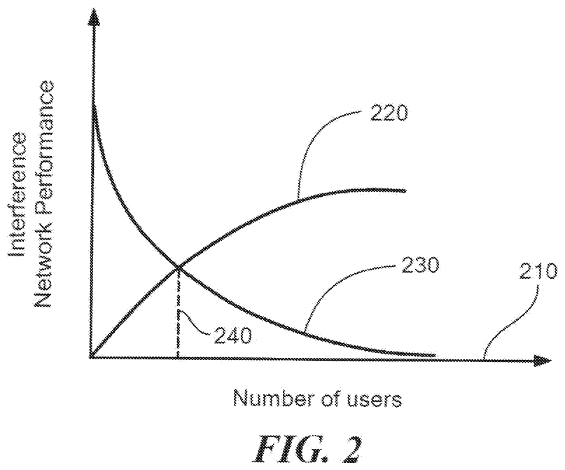

FIG. 2 shows base station performance and handoff considerations in the wireless network environment of FIG. 1. Referring to FIGS. 1 and 2, each base station 112 has a maximum bandwidth it can support, defined by the number of connected subscriber devices and the bandwidth allocated to each subscriber device. The wireless base station 112 manages transmits and receives wireless services (Internet browsing, streaming, texting, email, etc.) according to a transmission scheme that strives to separate transmissions to different subscriber devices and minimize interference, usually through the use of orthogonal codes or other technology known in the art. For a give base station, as the number of users (axis 210) increases, interference 220 also increases as the base station 112 tries to separate transmissions to individual subscriber devices 120. Concurrently, performance 230 also decreases as the base station 112 allocates bandwidth among additional subscriber devices 120. A handoff threshold 240 identifies a tradeoff between performance and interference where it is beneficial to offload users to other base stations 112.

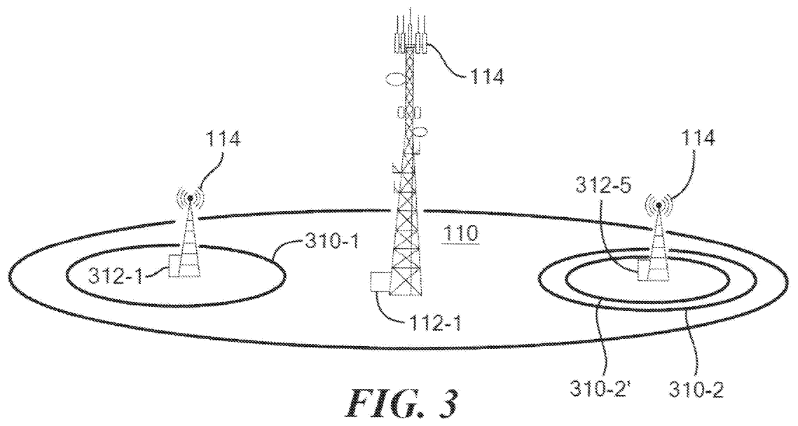

FIG. 3 shows small and macro cells between which handoffs occur as in FIG. 2, Referring to FIGS. 1-3, a small cell base station (312-1 . . . 312-2, 312 generally) may be established in regions of a particular concentration of users or demand.

Small cell base stations 312-1, 312-2, etc., serve small cells 310-1, 310-2, etc., (310 generally) that lie within a macro cell 110. Since a subscriber device 120 within the small cell 310 is also within the macro cell 110, it may be served by either the base station 112-1 of the macro cell 110 or a respective small cell base station 312 of the cell it resides in.

Subscriber devices 120 may be offloaded to the small cell base station 312 at appropriate times, such as when the base station 112 attains the handoff threshold 240. The small call base station 312 may be enabled and deactivated as needed to receive handoffs of subscriber devices 120 from the macro cell base station 112. It should be noted that with respect to the description herein, a base station, whether serving a small cell 312 or macro (large) cell 110 generally varies only with respect to a transmission power level for establishing a coverage region defined by a radius corresponding to the power level, and otherwise employ similar capabilities for wireless communication with the subscriber devices 120 within the respective coverage region. Power levels are discussed further below.

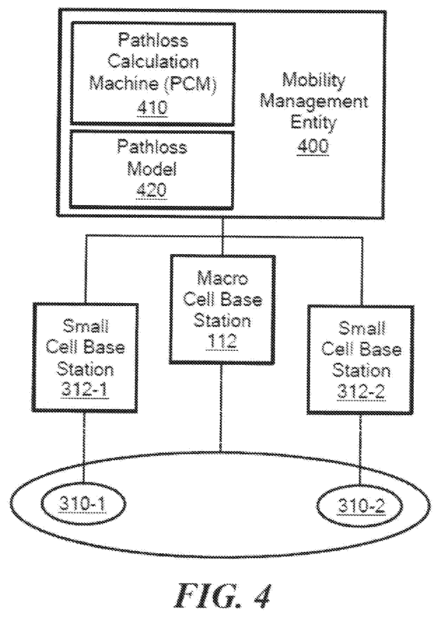

FIG. 4 is a block diagram of a wireless handoff system implementing a handoff in the cells of FIG. 3. Referring to FIGS. 3 and 4, a Mobility Management Entity (MME) 400 such as a handoff management resource controls handoffs between the cells for maintaining wireless performance between the user equipment and corresponding wireless base station as well as loading of each of the macro 110 and small cells 310.

In one embodiment, the MME 400 includes a Pathloss Calculation Machine (PCM) 410 for calculating location based pathloss between a subscriber device 120 (mobile communication device, user equipment, etc.) and a corresponding base station 112, 312 to which it is connected.

For example, in one embodiment, the MME 400 receives pathloss and loading info, makes handoff decisions based, at least in part, on a pathloss model 420 that stores pathloss information between a plurality of locations in the cell 110, cell 310 and the corresponding wireless base stations 112, 312 serving a respective cell.

As a more specific example, for a first location in the cell 310-1, the pathloss model 420 keeps track of a first pathloss value indicating a corresponding wireless communication pathloss between the first location and the wireless base station 312-1; for a second location in the cell 310-1, the pathloss model 420 keeps track of a second pathloss value indicating wireless communication pathloss between the second location and the wireless base station 312-1; for a third location in the cell 310-1, the pathloss model 420 keeps track of a third pathloss value indicating wireless communication pathloss between the third location and the wireless base station 312-1; and so on.

Additionally, for the first location in the cell 310-1, the pathloss model 420 keeps track of a first pathloss value indicating a corresponding wireless communication pathloss between the first location and the wireless base station 112-1; for the second location in the cell 310-1, the pathloss model 420 keeps track of a second pathloss value indicating wireless communication link pathloss between the second location and the wireless base station 112-1; for the third location in the cell 310-1, the pathloss model 420 keeps track of a third pathloss value indicating a wireless communication pathloss between the third location and the wireless base station 112-1; and so on.

Note that a respective pathloss at each location in a respective cell is affected by parameters such as distance between the location and the wireless base station, obstacles such as buildings, terrain, etc., hindering transmission of wireless communications from the location to the wireless base station and vice versa, etc. Based on such factors, even though a location may be quite close in proximity to the wireless base station 312-1, the wireless base station 112-1 may provide a lower pathloss option in which to connect a respective mobile communication device due to an obstacle blocking wireless communications between the mobile communication device and the wireless base station 312-1.

In one embodiment, the mobile management entity or other suitable resource generates the pathloss values based on prior mobile communication devices communicating from the respective location to the wireless base station or based on prior communications between the wireless base station and the mobile communication devices communicating from the respective location to the wireless base station at the location.

Pathloss can be determined in any suitable manner. In one embodiment, an initial pathloss estimate may be computed from a Sounding Reference Signal (SRS) and Channel State Information (CSI). For example, in one embodiment, the Sounding Reference Signal (SRS) is a reference signal transmitted by respective user equipment in an uplink direction which is used by the wireless base station (eNodeB) to estimate the uplink channel quality over a wider bandwidth. The wireless base station uses identified pathloss measurements as a basis to generate the pathloss model 420.

In one embodiment, the pathloss model 420 is continually updated with location specific pathloss information (as determined from continued testing) based on the locations 122 of the subscriber devices 120, in order to avoid a high granularity of pathloss computations that may result from a purely grid based pathloss metrics. The MME 400 sends handoff messages 420 to the wireless base station 112 and the small cell base stations 312 for performing handoffs.

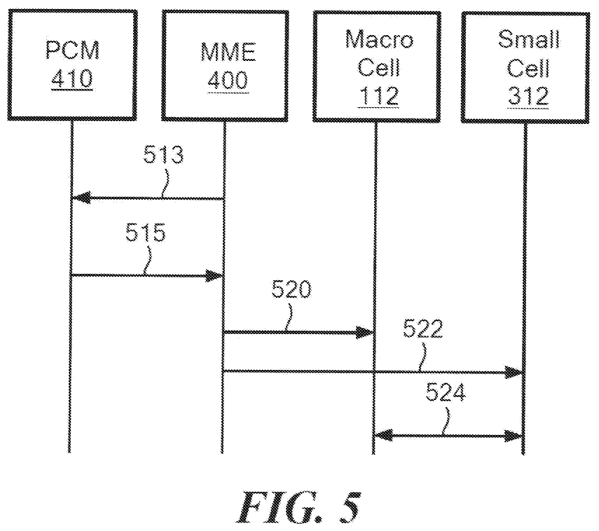

FIG. 5 shows a message flow for a handoff in the wireless handoff system of in FIG. 4. Referring to FIGS. 1 and 3-5, the MME 400 sends a location message 513 to the PCM 410 to indicate the position of a subscriber device 120. The PCM 410 returns a pathloss message 515 indicative of the pathloss to the macro cell base station 112 and a candidate small cell base station 312.

Since the PCM 410 operates on the actual location of the subscriber device 120, the pathloss calculation is able to account for interfering obstacles such as tall buildings and geographic anomalies, block respective wireless signals from reaching a desired destination (which results in higher pathloss). The MME 420 sends the handoff message 520 to the macro cell base station 112, and a complementary handoff message 522 to the receiving small cell base station 312. The small cell base station 312 replies with a handoff signaling 524 to indicate that it is in communication with the handed-off subscriber device 120.

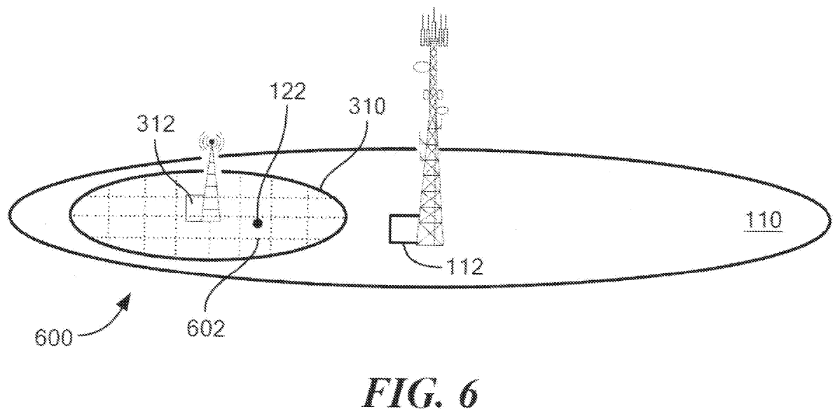

FIG. 6 shows a grid subdivision of elements in a wireless coverage region in a small or macro cell as in FIG. 3. Referring to FIGS. 1, 3, 4 and 6, consider the small cell 310 within the footprint (coverage area) of the macro cell 110. In an example configuration, the footprint of the small cell is divided into a grid 600 e.g., 20×20 m elements 602. As an initialization step for the pathloss model 420, pathloss for each element 602 is theoretically calculated using a propagation tool with a tuned model. These measurements can be tuned/adjusted once the small cell base station 312 has subscriber devices 120 to serve, and the PCM 410 can measure pathloss and channel related parameters using a SRS (Sounding Reference signal) and CSI (Channel state information) for uplink and downlink respectively from the actual location 122 of the subscriber device 120.

In one embodiment, the path loss model 420 describe the signal attenuation between a transmit and a receive antenna as a function of the propagation distance and other parameters between the transmitting wireless station and the receiving wireless station.

The pathloss model 420 is initialized and maintained by ongoing pathloss calculation and estimation from connected subscriber devices 120. Accordingly, computing the pathloss model 420 may include subdividing the coverage region 310 of the small cell into a grid arrangement 600 defining elements 602.

The PCM 410 computes an initial pathloss estimation for each element 602 of the grid arrangement 600, which is used to generate the pathloss model 420 of locations in the small call region 310 based on actual measured interference (pathloss) experienced by subscriber equipment at a location 122 in the service area.

Calculation of the pathloss with respect to each of the base stations 112, 312 may further include transmitting a sounding reference signal from each of the first and second base stations (and/or user equipment), and identifying, based on the sounding reference signal, which of the first and second base stations incurs the least interference in communication with the user equipment.

This information is sent back to the MME 400 over control plane channels, and the pathloss model 420 may be updated with actual location information and adjusted over time. The pathloss model 420 therefore maintains pathloss based on the actual location 120 of the subscriber device 120, and continually updates to conform to pathloss affecting aspects of the service region 310 based on calculated pathloss from multiple subscriber devices 120.

Continuing to refer to FIGS. 3 and 4, in addition to use of the pathloss model 420 and loading factors of the base stations as a reference for handoffs, the size of the small cells 310 can also be adjusted to enlarge or contract the service region 310 to decrease interference or the number of users served by the small cell base station 312. The (macro) cell base station 112-1 establishes a transmission power level for covering the macro cell region 110. The small cell base stations 310-1, 310-2 establishes a transmission power level for covering the small cell region, at a lower transmission power level than the large cell base station 112-1 such that the small cell wireless cells 310-1, 310-2 (coverage regions) are within the wireless coverage region of the macro cell 110.

In general, this means setting the wireless transmission power level of the small cell base stations 312 below a threshold that causes interference with users connected to the wireless base station 112 for the macro cell region 110 in which the small cell is located. The small cell region 310 is therefore effectively adjusted for power and corresponding coverage region to handle a number of users to relieve the large cell base station 112 without hindering the users handled by the large cell base station 112.

In addition to managing a number of subscriber devices 120, and therefore the load, borne by the respective base stations based on the calculated pathloss and location of individual users, the wireless power level of the base stations may also be adjusted to enlarge or contract the coverage region 110, 310, for accommodating or reducing handoffs.

Accordingly, the MME 400 may direct adjusting the transmission power level of the wireless base station 312-2 serving the small cell region 310-1 based on a size of the wireless coverage region of the small cell 310-2 and interference within the wireless coverage region of the small cell. Such adjustment may include reducing the coverage region of the cell 310-2 to that of the inner circle 310-2′.

In other words, the MME 400 may reduce the wireless transmission power of the wireless base station 312-1 serving the small cell 310-1 for reducing a coverage area 310-2′ in response to a reduced load at a corresponding macro cell 110 region. This allows more users to be switched (handed off) to the large cell base station 112 and reduces or eliminates the burden on the small cell base station 312-2. As a performance consideration, if the user load of the small cell can be reduced to zero, the small cell may be shut down.

Conversely, corresponding enlargement of the coverage region from circle 310-2′ to 310-2 in circumstances when it is undesirable to handoff a respective mobile communication device in region of wireless coverage 310-2 associated with the wireless base station 312-2 to the wireless base station 112-1 such as due to an excessive load on wireless base station 112-1. In such an instance, embodiments herein can include increasing the region of wireless coverage provided by the wireless base station 312-2.

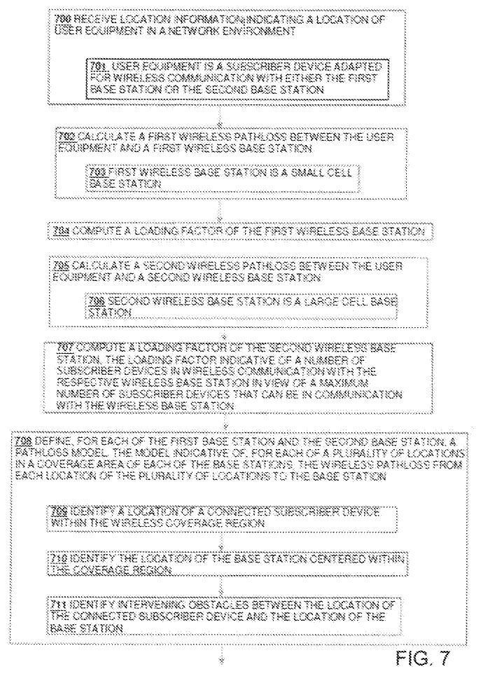

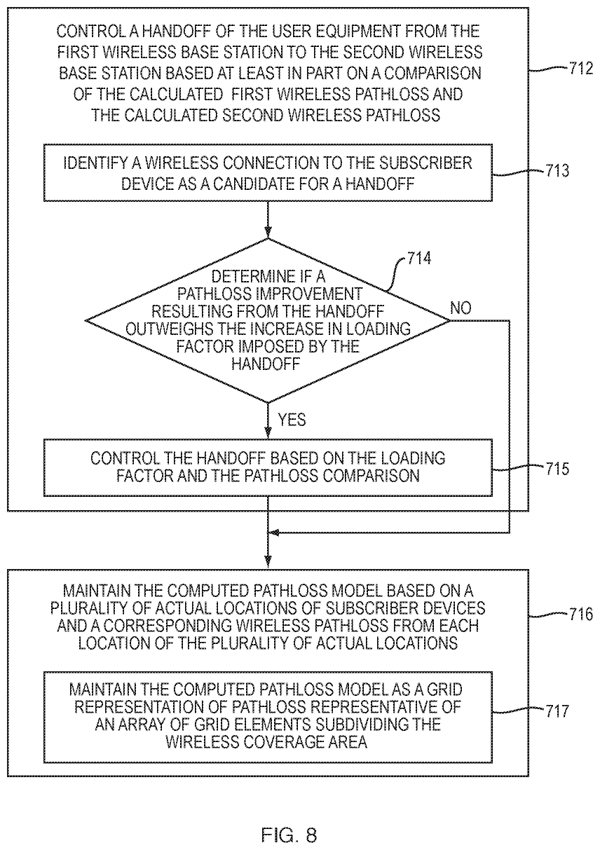

FIGS. 7A and 7B are a flowchart of location and pathloss based handoffs in the environment of FIG. 1.

Referring to FIGS. 1-7, at step 700, the MME 400 (management entity such as hardware and/or executed switch) receives location information indicating a location 122 of user equipment 120 in the network environment 100. As indicated above, the user equipment is generally a subscriber device adapted for wireless communication with either the first base station or the second base station, and may take a variety of types including cellphone and tablet type devices, as disclosed at step 701.

For example, the PCM 410 calculates a first wireless pathloss between the user equipment and a first wireless base station 312, as depicted at step 702. In the example herein, the first wireless base station is a small cell base station, as shown at step 703.

The MME 400 computes a loading factor of the first wireless base station 312 at step 704 to identify how heavily burdened the first wireless base station 312 is. The MME 400 calculates a second wireless pathloss (performance) between the user equipment and a second wireless base station 112, as shown at step 705, in which the second wireless base station is a large cell base station, depicted at step 706.

In the small cell examples shown, the region of wireless coverage 310 provided by the first wireless base station 312 resides within a region of wireless coverage 110 of the second wireless base station 112. The examples herein employ handoffs between small cell and large (macro) cells served by corresponding base stations, however the method is applicable for handoffs between any suitable base stations. For example, cells regions generally share an overlapping region at the outermost range of the cell. Such an overlapping region is also suitable for a handoff—it need not occur in a cell completely within the service region of another cell.

The MME 400 computes a loading factor of the second wireless base station 112, such that the loading factor is indicative of a number of subscriber devices 120 in wireless communication with the respective wireless base station in view of a maximum number of subscriber devices that can be in communication with the wireless base station, as disclosed at step 707.

The PCM 410 defines, for each of the first base station 312 and the second base station 112, a pathloss model 420, such that the pathloss model 420 is indicative of, for each of a plurality of locations 122 in a coverage area 110, 310 of each of the base stations 112, 312, the wireless pathloss from each location 122 of the plurality of locations to the base station, as depicted at step 708.

Therefore, the PCM 410 computes the pathloss model 420 (a.k.a., a performance model) in the wireless coverage region around the wireless base station, such that the pathloss model is indicative of the wireless pathloss between the user equipment and a respective wireless base station. The pathloss model 420 is generally denoted by a data structure and volatile or non-volatile memory repository for storing the respective pathloss from each of the plurality of stored locations to the respective base station, as shown at step 708. The pathloss model 420 identifies a location of a connected subscriber device 120 within the wireless coverage region 110, 310, as depicted at step 709, and the location of the base station 112, 312 centered within the coverage region, shown at step 710. The pathloss model 420 also accounts for the pathloss impact of intervening (wireless-signal-blocking) obstacles between the location of the connected subscriber device 120 and the location of the base station 112, 312, as depicted at step 711. Generally, the obstacles include man-made structures and geographic impositions, for example skyscrapers, hills, or even thick trees may affect signal propagation and result in an increased pathloss for a particular location.

The MME 400 controls a handoff of the user equipment, such as subscriber device 120, from the first wireless base station to the second wireless base station based at least in part on a comparison of the calculated first wireless pathloss and the calculated second wireless pathloss, as disclosed at step 712.

Often, different base stations will transmit from a different direction, and a more favorable direction, having less pathloss, may be beneficial. In other words, when the pathloss model 420 indicates a lower pathloss resulting from a handoff, the handoff will be performed based on the pathloss and location of the subscriber device 120. Thus, in addition to loading considerations such as how many mobile communication devices each of the wireless base station 112 and wireless base station 312 serve, embodiments herein include using pathloss as a basis to initiate a handoff.

The MME 400 identifies a wireless connection to the subscriber device as a candidate for a handoff, as shown at step 713. A check is performed, at step 714, to determine if a pathloss improvement resulting from the handoff outweighs the increase in loading factor imposed by the handoff. If so, then the MME 400, using the pathloss model, controls the handoff based on the loading factor and the pathloss comparison, and performs the handoff based on the determination, as shown at step 715.

Otherwise, control passes to step 716 if the handoff would not be beneficial. The PCM 410 continues to maintain the computed pathloss model 420 based on a plurality of actual locations of subscriber devices 120 and a corresponding wireless pathloss from each location of the plurality of actual locations 122. The pathloss model 420 is therefore continually updated. This may include maintaining or initializing the computed pathloss model as a grid representation 600 of pathloss representative of an array of grid elements 602 subdividing the wireless coverage area, as depicted at step 717. Location information specific to the subscriber devices 120 is employed to refine the pathloss model based on specific locations 122.

In certain scenarios, it may be beneficial to separately transmit uplink and downlink traffic (from/to the base station) from different base stations. The MME 400 determines the wireless pathloss on an uplink to each of the first and second wireless base stations, and concludes a lower pathloss on the uplink to the first wireless base station. The MME 400 directs a wireless connection to the first wireless base station for uplink traffic and a connection to the second wireless base station for downlink traffic, or vice versa, depending on demands.

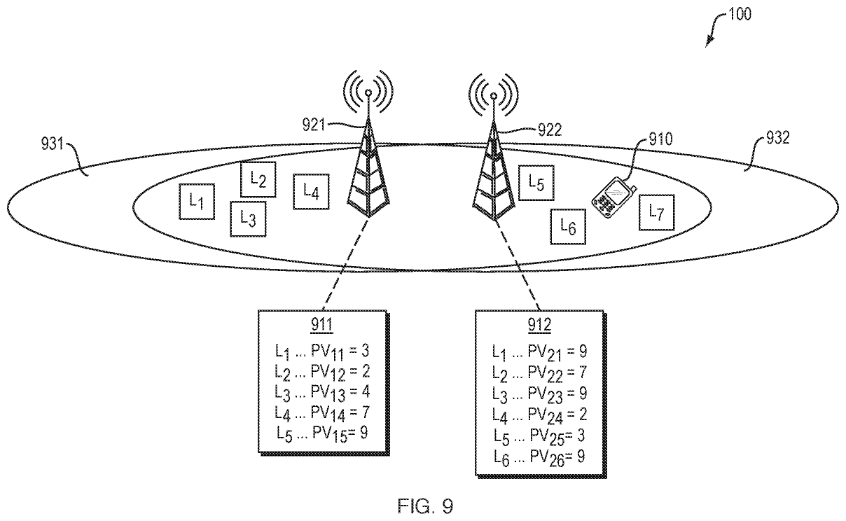

FIG. 9 is an example diagram illustrating a network environment including a first base station operated by a first service provider and a second base station operated by a second service provider according to embodiments herein.

In this example embodiment, a so-called MVNO (Mobile Virtual Network Operator) is a wireless service provider that doesn't own its own physical network infrastructure, but rather depends on mobile network providers (MNOs or Mobile Network Operators) through a contract to provide services to the MVNO's customers (subscribers operating respective user equipment).

Consider an MVNO that has contracted use of two MNOs, namely, wireless network service provider #1 and wireless network service provider #2.

To provide the best reliability, performance, and wireless coverage of the two MNOs, usually one MNOs is designated as a primary service provider while the other one is a secondary service provider.

It is assumed that the user equipment 910 will generally, if possible, connect to the primary service provider (such as wireless network service provider #1 in this case). In the event that there is no wireless service available from the primary provider or the primary cell wireless base station 921 is down (incapable of provide user equipment 910 to a remote network), the user equipment 910 will connect to the secondary wireless base station 922. It should be noted that this is usually not an ideal approach both from a cost perspective as well as perspective of efficient use of resources.

Consider a case, where operator #1 (wireless network service provider #1) is designated as a primary wireless network service provider and operator #2 (wireless network service provider #2) is designated as the secondary wireless network service provider. As shown, each network has a different footprints (regions of wireless coverage), performance, and loading. For example, the wireless base station 921 provides region of wireless coverage 931; the wireless base station 922 provides region of wireless coverage 932.

In one embodiment, the user equipment 910 will automatically connect to the primary network (wireless base station 921) even if it has a higher pathloss, higher user equipment load, etc., than the wireless base station 922. This condition isn't an optimal situation as the secondary network (wireless base station 922) may be able to provide better service at the user equipment's 910 current location.

In this example embodiment, note that performance model 911 keeps track of performance at different locations in the network environment. For example, performance model 911 indicates that the first wireless base station 921 provides a wireless link performance level of PV11=3 to any user equipment at location L1; performance model 911 indicates that the first wireless base station 921 provides a wireless link performance level of PV12=2 to any user equipment at location L2; performance model 911 indicates that the first wireless base station 921 provides a wireless link performance level of PV13=4 to any user equipment at location L3; performance model 911 indicates that the first wireless base station 921 provides a wireless link performance level of PV14=7 to any user equipment at location L4; performance model 911 indicates that the first wireless base station 921 provides a wireless link performance level of PV15=9 to any user equipment at location L5; and so on. Note that each location L1, L2, etc., can be configured to represent a small region such as 20 meters×20 meters or other suitable sized location values.

Accordingly, the performance model 911 provides an indication of expected wireless performance levels associated with the wireless base station 921 for each of multiple different locations (regions in a grid).

In this example embodiment, note that performance model 912 keeps track of performance at different locations in the network environment. For example, performance model 912 indicates that the second wireless base station 922 provides a wireless link performance level of PV21=9 to any user equipment at location L1; performance model 912 indicates that the second wireless base station 922 provides a wireless link performance level of PV22=7 to any user equipment at location L2; performance model 912 indicates that the first wireless base station 922 provides a wireless link performance level of PV2=9 to any user equipment at location L3; performance model 912 indicates that the second wireless base station 922 provides a wireless link performance level of PV24=2 to any user equipment at location L4; performance model 912 indicates that the second wireless base station 922 provides a wireless link performance level of PV25=3 to any user equipment at location L5; performance model 912 indicates that the second wireless base station 922 provides a wireless link performance level of PV26=9 to any user equipment at location L6; and so on.

Accordingly, the performance model 912 provides an indication of expected wireless performance levels associated with the wireless base station 922 for each of multiple different locations (regions in a grid).

In one embodiment, the corresponding metric assigned to the performance value (PV) for each performance model indicates a degree to which the wireless base station provides good wireless connectivity (such as based on one or more parameters such as pathloss, available bandwidth, etc.) to a remote network.

For example, assume that a PV value of 0 indicates that a respective wireless base station provides very poor wireless connectivity (high bit error rate, low bandwidth, poor signal strength, high pathloss, etc.) between the wireless base station and the corresponding location; a PV value of 5 indicates that a respective wireless base station provides moderately good wireless connectivity (medium bit error rate, medium bandwidth, moderate signal strength, moderate pathloss, etc.) between the wireless base station and the corresponding location; a PV value of 10 indicates that a respective wireless base station provides a best wireless connectivity (lowest bit error rate, high bandwidth, high signal strength, low pathloss, etc.) between the wireless base station and the corresponding location.

In one embodiment, this location (sector) and CSI (used to calculate performance such as pathloss) would be stored in a matrix (performance model 911 and performance model 912) defined over a geographical area divided into sectors such as locations L1 (first geographical region), L2 (second geographical region), L3 (third geographical region), L4 (fourth geographical region), etc. Note that higher granularity of the grid sectors (size of location region) would provide more accurate results.

Note that the information stored in the performance models 921 and 922 can be collected and updated in any suitable manner. For example, embodiments herein include receiving feedback from user equipment and/or respective wireless base station in the network environment 100. The received feedback includes one or more parameters indicating an ability of the respective mobile communication devices to communicate from the corresponding location of interest to each of the wireless base stations. As previously discussed, feedback can indicate metrics such as signal strengths of wireless communications between the different user equipment and wireless base stations; supported date rates; bit error rates; etc., based on communications between a respective location and the corresponding wireless base station.

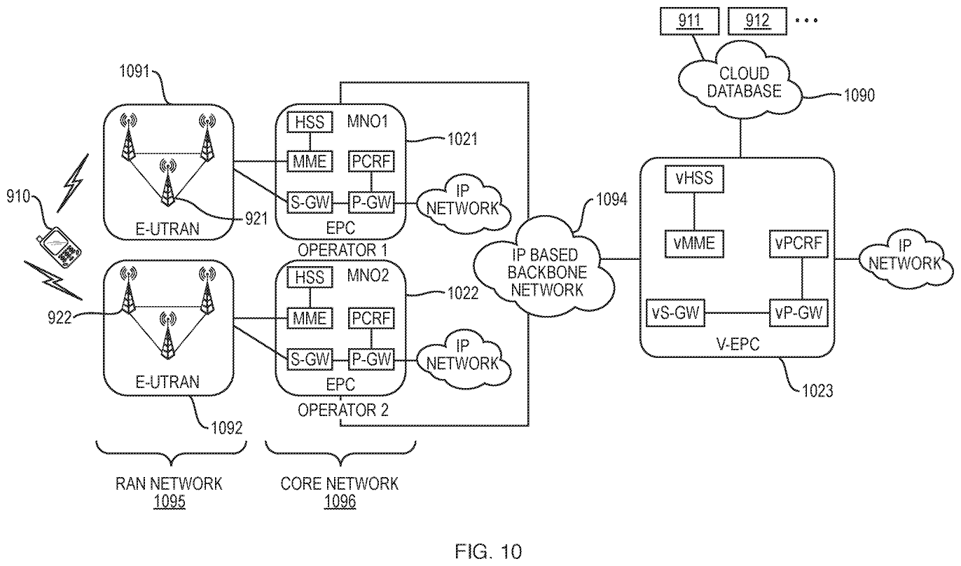

FIG. 10 is an example diagram illustrating management of a handoff according to embodiments herein.

In one embodiment, when new user equipment such as user equipment 910 enters the network environment 100, the MME associated with communication management resource 1023 analyzes historical data and grid sections associated with performance models 911 and 912 (performance/location) and assigns an appropriate wireless base station (from either operator #1 or operator #2) to the user equipment 910. For example, in one embodiment, the communication management resource 1023 selects a wireless base station that provides a best or better performance (such as lower pathloss) to the corresponding user equipment 910, thus enabling the user equipment 910 (i.e., mobile communication device) with higher data rates and better user experience.

As further discussed herein, the network architecture in FIG. 10 implements the performance models 911, 912, etc., to provide best wireless connectivity to the user equipment 910. More specifically, in one embodiment, the MVNO has virtual network elements that are used to control UE's (such as user equipment 910) subscribed to the MVNO. The MVNO cannot over-ride the main operators, but from the UE's perspective, it appears just as any network with both operator sites visible as its own. CSI and location data from the UE is available at EMS of the MVNO.

Consider the two different MNOs (such as MNO1 and MNO2) in FIG. 10. They both operate independently and provide wireless services to their respective mobile device subscribers. Assuming that an MVNO (such as communication management resource 1023 and corresponding network components) is connected to and has an agreement with both the operator's networks through IP network 1090. In such an instance, the MVNO has a full core network (i.e., a full evolved packet core).

In accordance with further embodiments, the MVNO EPC (communication management resource 1023) doesn't have full control over the RAN network 1095 since the individual core networks 1096 of MNOs (such as MNO1 and MNO2) control (via respective communication management resource 1021 and communication management resource 1022) their individual networks according to their network policies and KPI thresholds.

Further in this example embodiment, however, the MVNO EPC (communication management resource 1023) has key information on user equipment and the RAN networks of the two MNOs. Traditionally, MNOs have MVNO relations with other providers in areas where they don't have infrastructure and leverage resources of other MNOs for coverage. This relationship is usually static and the user equipment remains ON or moves to the other MNO, i.e., the user equipment would move to a different MNO only when it doesn't have coverage from the primary MNO.

Embodiments herein include providing a more dynamic relation between the MNOs by selecting a respective MNO (and corresponding wireless base station) based on different expected performances at a given location where the user equipment resides. For example, consider a geographical area, at a granularity of a census tract. In that census tract, operator 2 may provide user equipment better wireless connectivity than operator 1. However, in conventional cases, the UEs subscribed to MVNO will remain on operator 1 due to static nature of the MVNO relationship. In order for the MVNO (communication management resource 1023) to be able to switch UEs to operator 2, the MVNO defines a message flow that allows a transparent handover of the UEs from one network to another.

Further discussion of providing wireless connectivity based on performance models 911 and 912 is discussed below.

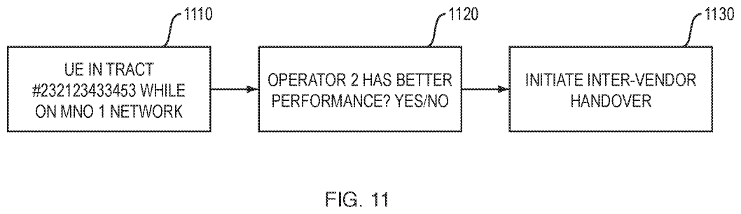

FIG. 11 is an example diagram illustrating monitoring of different performances associated with different wireless base stations and initiating a handoff according to embodiments herein.

Consider that user equipment is originally wirelessly connected to operator #1 in network 1091. When the user equipment 910 enters a census tract (location) where operator 2 (such as network 1092) provides better performance at the corresponding new location of the user equipment 910, the communication management resource 1023 (MVNO) initiates a handover process from one wireless base station to another in accordance with the performance models 911 and 912.

For example, in processing operation 1110, the communication management resource 1023 detects a location of the user equipment 910. In other words, the user equipment 910 is known to the MVNO core network (1023). Census tract level performance information (as indicated by the performance models 911, 912, etc.) is stored in the cloud or other suitable location. When the user equipment 910 crosses a census boundary (exits a region into a new region), the communication management resource 1023 looks up the performance of the operators (via performance models 911 and 912) for the particular location of the user equipment 910.

If the wireless connectivity performance provided by operator 2 and corresponding wireless base station 922 (as indicated by the performance model 912) is better than that provided by wireless base station 921 as determined in processing operation 1120 (via performance model 911) as described herein, the communication management resource 1023 initiates a handover in processing operation 1130 as further discussed below.

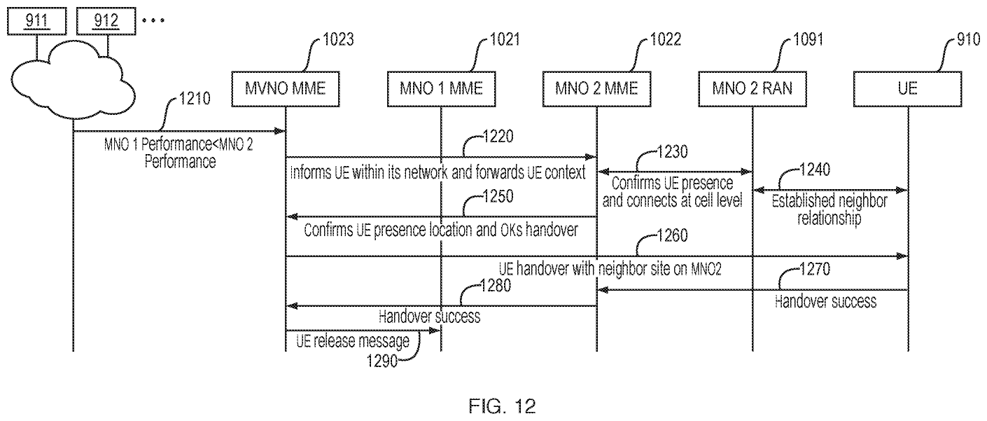

FIG. 12 is an example diagram illustrating management flow of handing off user equipment from a first wireless base station (operated by a first wireless network service provider) to a second wireless base station (operated by a second wireless network service provider) according to embodiments herein.

The handover process is explained with respect to communication flow 1200 in FIG. 12. In general, the communication management resource 1023 (MVNO EPC) establishes MNO 2's EnodeB (wireless base station 922) as neighbors of MNO 1 enodeB (wireless base station 921) to the UE 910 and initiates a command to the UE 910 to move to a neighboring site (wireless base station 922, such as provided by a second wireless network service provider) with better performance.

More specifically, via communications 1210, the communication management resource 1023 detects, via lookup mapping into performance model 911 and 912, that the wireless base station 922 at the particular location (such as L2) provides better performance of wireless connectivity to the user equipment 910 than wireless base station 921 for location L2. For example, the performance metric PV12=2 for the performance model 911 (associated with first wireless network) at location L2 while the performance metric PV22=7 for the performance model 912 (associated with the second wireless network) at location L2.

Via communications 1220, the communication manager resource 1023 (such as MVNO MME) informs user equipment in its network and forwards user equipment context information to the communication management resource 1022 (such as MNO2 MME).

Via communications 1230, the communication manager resource 1021 (MNO 2 MME) confirms user equipment presence and connects at the cell level.

Via communications 1240, the network 1091 (MNO 2 RAN) notifies the user equipment 910 of the established neighbor relationship.

Via communications 1250, the communication management resource 1022 (MNO 2 MME) confirms user equipment presence location and OKs the handover.

Via communications 1260, the communication management resource 1023 (MVNO MME) initiates the user equipment 910 handover with the neighbor site (wireless base station 922) on MNO2.

Via communications 1270, the user equipment 910 provides notification of handover success (of handing off from the wireless base station 921 to the wireless base station 922) to the communication management resource 1022 (MNO 2 MME).

Via communications 1280, the communication management resource 1023 (MNO 2 MME) provides notification of the handover success to the communication management resource 1023 (MVNO MME).

Via communications 1290, the communication management resource 1023 provides notification of the user equipment lease (handoff from wireless base station 921 to wireless base station 922) to the communication management resource 1021 (MNO 1 MME).

In one embodiment, the process of handover is transparent to the user equipment 910; that is, the user equipment 910 does not detect the handover to a new MNO, which reduces the time required for a handover and routing of traffic from one MNO to another. Hence, reducing the latency as well.

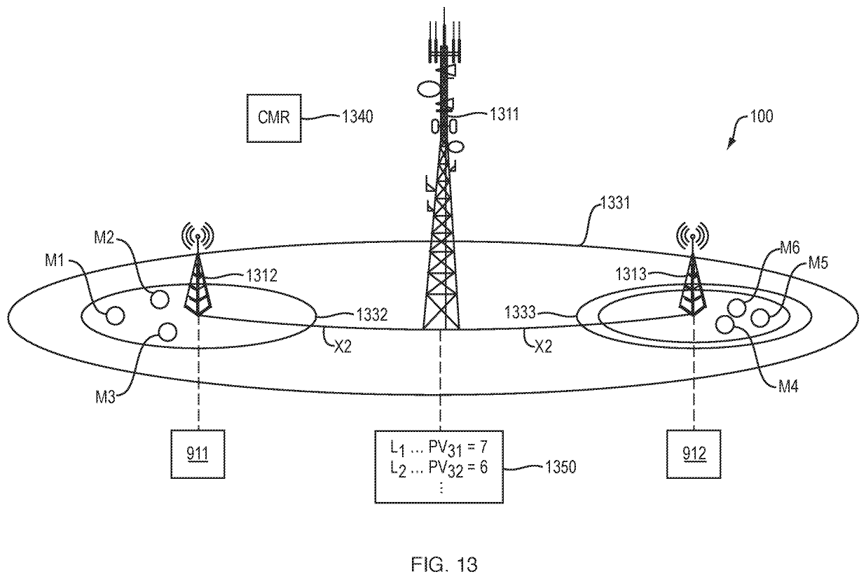

FIG. 13 is an example diagram illustrating adjusting a wireless coverage region supported by a small cell wireless base station according to embodiments herein.

It is noted that LTE (Long Term Evolution) release 8 and later have a universal frequency re-use pattern, which means all cells in a cluster operate on the same frequency and channel. Macro cells (large cells) such as wireless base station 1311 are typically meant to provide ubiquitous coverage over a large region of wireless coverage 1331 area such as shown in FIG. 13.

For example, large cell wireless base station 1311 supports region of wireless coverage 1331; small cell wireless base station 1312 supports region of wireless coverage 1332; small cell wireless base station 1313 supports region of wireless coverage 1333; and so on.

In one embodiment, as the load on these cells increases, as shown in FIG. 2, the network's ability to provide good wireless connectivity to all user equipment diminishes. In general, FIG. 2, illustrates the break-even point 240 where further loading of the network would result in degraded user throughput performance.

In order to provide better throughput (higher wireless data rates) to users, the network environment 100 in FIG. 13 includes small cell wireless base stations 1312, 1313, etc., in order to offload users (user equipment) from the large cell wireless base station 1311 (macro site) supporting region of wireless coverage 1331.

In one embodiment, small cells (such as wireless base station 1312 and 1313) are generally deployed in areas with high densities or expected high densities of user equipment usage. Additionally, there is usually a large difference in transmission powers of the macro and small cells. For example, the macro cell stations (such as wireless base station 1311) transmits at a much higher power level than the small cell stations (such as wireless base stations 1312 and 1313). The small cell wireless base stations, if not set at proper transmit power levels, would cause interference to the macro sites (1311) and surrounding cells.

In general, EnodeBs in respective macro sites having stronger transmission power would end up serving more mobile communication devices/users over time. In one embodiment, the network tracks the location of these users/mobile communication devices using triangulation or GPS reported location.

In yet further embodiments, when the network environment 100 in FIG. 13 reaches the break-even point 240 in FIG. 2, the macro site (wireless base station 1311) of FIG. 13 starts to offload user equipment to small cells (such as wireless base station 1312 and 1313) by communicating over communication link X2 between the wireless base station 1311 and each of the wireless base stations 1312 and 1313. In one embodiment, the communication link X2 provides low latency communications, and tight interworking between the sites for efficient transition without disrupting high quality user experience.

Note that this network off-loading of user equipment to the small cell wireless base stations is no-longer needed when the load on the large wireless base station cells starts to diminish. In such an instance, the macro cell wireless base station 1311 will pick up users (via handoffs of user equipment from the small cells to the large cell wireless base station 1311) when pre-defined KPI's reach their thresholds.

Referring again to FIG. 13, embodiments herein include deactivating (turning OFF) small cell wireless base station 1312 and 1313 to reduce energy consumption under light to moderate loading of the macro cell wireless base station 1311.

In one embodiment, for each location in a corresponding region of wireless coverage, the small cell wireless base stations 1312 and 1313 measures location and respective performance parameters (such as pathloss, bit error rate, bandwidth, wireless communication signal strength from the mobile communication devices, etc.) for each different location in the region of wireless coverage 1332 and 1333 in order to generate the respective performance models 911 and 912 as previously discussed.

Assume in this example embodiment that performance model 911 of FIG. 9 is generated for wireless station 1312 and that performance model 012 of FIG. 9 is generated for wireless station 1313.

Referring again to FIG. 13, note that embodiments herein further include generating a respective performance model 1350 associated with the wireless base station 1311 as well. In such an instance, the performance model 1350 maps each location in the region of wireless coverage 1331 to a respective metric indicating an expected performance level of wireless communications between the location and the wireless base station 1311 in a similar manner that the performance models 911 and 912 provide permission metrics, however wireless coverage for the wireless station 1311 is much larger.

In one embodiment, each of the performance models 911 and 912 (as well as performance model 1350) represents a matrix in which to lookup performance provided by the respective wireless base station. More specifically, for each location supported by a respective wireless base station, the performance model provides a mapping of the location to a performance value indicative of performance provided by the wireless base station to user equipment at the location.

As previously discussed, the performance models can be stored at a central location accessible to a handoff management (hardware and software) that uses the performance models to determine whether to perform a respective handoff.

In one embodiment, each time the macro wireless base station 1311 site is trying to offload (handoff) currently connected user equipment to a small cell wireless base station, a respective handoff manager associated with the wireless base station 1311 compares various UE locations and corresponding mapped performance information (such as pathloss) to that of various small cell matrices to find which corresponding small cells to turn ON.

For example, assume on average that the performance model 911 indicates that an average connection quality level associated with all locations in the region of wireless coverage 1332 is a value of 7 while the performance model 912 indicates that an average connection quality level associated with all locations in the region of wireless coverage 1333 is a value of 5. In such an instance, because on average the wireless base station 1312 is better that wireless base station 1313 for supporting better quality wireless communication links, the communication management resource can be configured to select activation of the wireless base station 1312 for handing off respective user equipment from the wireless base station 1311.

Further embodiments herein can include ranking each of multiple different small cell wireless base stations based on their respective performance models and current connected users/mobile communication devices. For example, wireless base stations that have corresponding performance models that provide highest performance of respective communication links are ranked highest in the ranking for activation by the communication management resource. In addition to ranking based on performance models, the decision to activate a small cell wireless base station can include taking into account a number of mobile communication devices that can be handed off to the different small cell wireless base station.

Accordingly, the performance models can be used to provide an overall assessment of whether respective user equipment could be served better by the macro wireless base station 1311 or a small cell wireless base station such as station 1312 and/or 1313.

Embodiments herein thus include, via the communication management resource 1340, producing a first performance model 911 indicating a performance ability of a first wireless station 1312 to provide wireless coverage 1332 to user equipment (such as mobile devices M1, M2, and M3) at multiple different locations (M1 at location L1, M2 at location L2, M3 at location L3) in a first region of wireless coverage 1332; the first region resides in a region of wireless coverage 1331 provided by a wireless station 1311. Communication management resource 1340 produces performance model 912 indicating an ability of a second wireless station 1313 to provide wireless coverage to user equipment (such as mobile devices M4, M5, M6) at multiple different locations (M4 at location L4, M5 at location L5, M6 at location L6) in a second region; the second region resides in the region of wireless coverage 1331 provided by the wireless station 1311.

In one embodiment, the communication management resource 1340 detects a condition such as that wireless station 1311 supports wireless connectivity to too many mobile devices. Assume that both the first wireless station 1312 and 1313 are both deactivated in which the wireless station 1311 supports wireless connectivity with mobile devices M1, M2, M3, M4, M5, and M6 as well as other mobile devices in region of wireless coverage 1331. To offload (handoff) mobile devices, the communication management resource 140 selects amongst the first wireless station 1312 and the wireless station 1313 depending on performance models 911 and 912. In this example embodiment, assume that the communication management resource 1340 selects activation of the first wireless station 1312 in lieu of selecting activation of the second wireless station 1313 based on the first performance model 911 and the second performance model 912.

In one embodiment, the decision of which of one or more multiple small wireless cell stations to activate via use of respective performance models includes, at the communication management resource 1340: receiving first locations (L1, L2, and L3) of first mobile devices (M1, M2, and M3) in wireless connectivity with the wireless station 1311; receiving second locations (L4, L5, and L6) of second mobile devices (M4, M5, and M6) in wireless connectivity with the wireless station 1311; and via the first performance model 911, determining an expected performance ability of the first wireless station 912 to provide wireless connectivity to the first mobile devices at the first locations; via the second performance model 912, determining an expected performance ability of the second wireless station 913 to provide wireless connectivity to the second mobile devices at the second locations; and selecting activation of the wireless station 912 in lieu of selecting activation of the second wireless station 913 in response to detecting that the expected performance ability of the wireless station 912 to provide wireless connectivity to the first mobile devices at the first locations is greater, on average, than the expected performance ability of the second wireless station 1313 to provide wireless connectivity to the second mobile devices at the second locations. For example, according to performance model 911, performance for locations L1=3, L2=2, L3=4; in which average performance=3. According to performance model 912, performance for locations L4=2, L5=3, L6=9; in which average performance=4.66.

After selecting and activating wireless station 1312, the wireless station 1311 initiates a handoff of a set of mobile communication devices (mobile devices M1, M2, and M3) to the wireless station 1312.

In yet further embodiments, note that the communication management resource 1340 can be configured to control a size of the wireless coverage region 1332 provided by the wireless station 1312 region depending on interference with the wireless station 1311.

In yet further embodiments, after a time duration, the communication management resource 1340 deactivates the wireless station 1312 in response to detecting that a load of wireless mobile communication devices supported by the wireless station 1312 falls below a threshold value. For example, assume that the mobile devices M2 and M3 terminate a respective wireless communication link with the wireless station 1312. In such an instance, only one mobile device M1 remains connected to the wireless station 1312. To save on power, the communication management resource 1340 initiates a handoff of the mobile device M1 to the wireless station 1311 and deactivates the wireless station 1312.

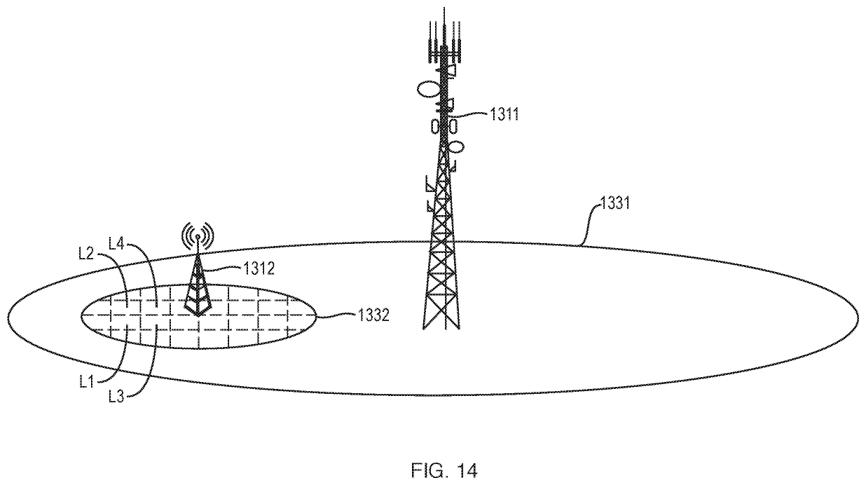

FIG. 14 is an example diagram illustrating comparison of a small cell wireless base station to a large cell wireless base station according to embodiments herein.

Consider a small cell wireless base station 1312 providing region of wireless coverage 1332 within the region of wireless coverage 1331 provided by macro cell wireless base station 1311.

In one embodiment, as previously discussed, the region of wireless coverage 1332 (footprint) of the small cell is divided into a grid of multiple locations (such as shown, for example, 20×20 square meter regions or other suitable value).

Performance information such as pathloss or other suitable parameters for these bins (locations or areas of the grid) is theoretically calculated using a propagation tool with a tuned model. These measurements can be tuned/adjusted once the small cell wireless station 1312 has multiple mobile communication devices (UEs) to serve and the wireless base station 1312 or other suitable resource can measure pathloss and channel related parameters using SRS (Sounding Reference signal) and CSI (Channel state information) for uplink and downlink respectively.

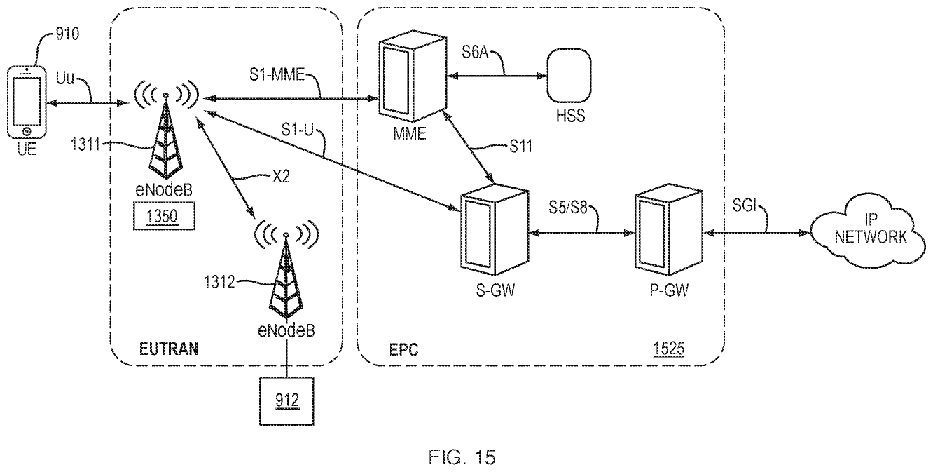

With reference to FIG. 15, this information (such as performance or pathloss information) is sent over S1-MME link back to the communication management resource 1525 (such as MME) over a control plane. In such an instance, the MME associated with the communication management resource 1525 stores this performance information (such as pathloss information) and updates and adjusts, over time, the corresponding performance model 912 to which the information pertains.

In yet further embodiments, the MME associated with the communication management resource 1525 will look at the UE data of the macro site. For example, a UE (User Equipment) heat map corresponding to the location of UEs within the footprint of the macro-cell. If the load on the macro cell wireless base station 1311 exceeds a pre-defined threshold, the MME will look at the historic heatmap of a small cell and if a certain number of UEs are detected within the footprint of a small cell, that small cell wireless base station 1312 will be turned on.

In one embodiment, the communication management resource 1525 (MME) stores the performance information associated with each location (such as location L1, location L2, location L3, etc.) in a table including a data field to store, for each location in the grid, a geographical tag for the corresponding grid location, pathloss information indicating a respective wireless signal pathloss between the location and the respective wireless base station, median number of mobile communication devices in communication with the wireless base station over time, number of mobile communication devices in a grid, total number of mobile communication devices in the region of wireless coverage 1332, etc.

In one embodiment, the information can be used to determine UEs that are within the footprint of a small cell wireless base station.

As previously discussed, FIG. 15 is an example diagram illustrating use of a respective small cell wireless base station to provide wireless connectivity according to embodiments herein.

In one embodiment, the macro cell wireless base station 1311 is controlled to offload currently connected user equipment to the small cell wireless base station 1312 or 1313. In such an instance, the macro cell wireless base station 1311 forwards the context information associated with the user equipment to be handed off to the small cell wireless base station 1312 for a quick seamless handover over Si as shown in FIG. 15.

Note that, in one embodiment, as the user equipment load starts to drop on a given small cell wireless base station 1312 or 1313, such as by reaching a minimum threshold value of user equipment, the respective MME (communication management resource) can be configured to turn OFF (deactivate) the small cell wireless base station 1312 or 1313 to reduce power consumption.

In accordance with further embodiments, note that, depending on the user equipment load and interference for a given small cell wireless base station, the communication management resource (MME) can be configured to adjust power of small cell wireless base stations 1312 and 1313. In such an instance, the region of wireless coverage of the small cell wireless base station will effectively be controlling distribution of different mobile communication devices (i.e., UEs) across the network footprint. In one embodiment, this is achieved via historic data and key KPIs and stats to set thresholds to maximize network resources.

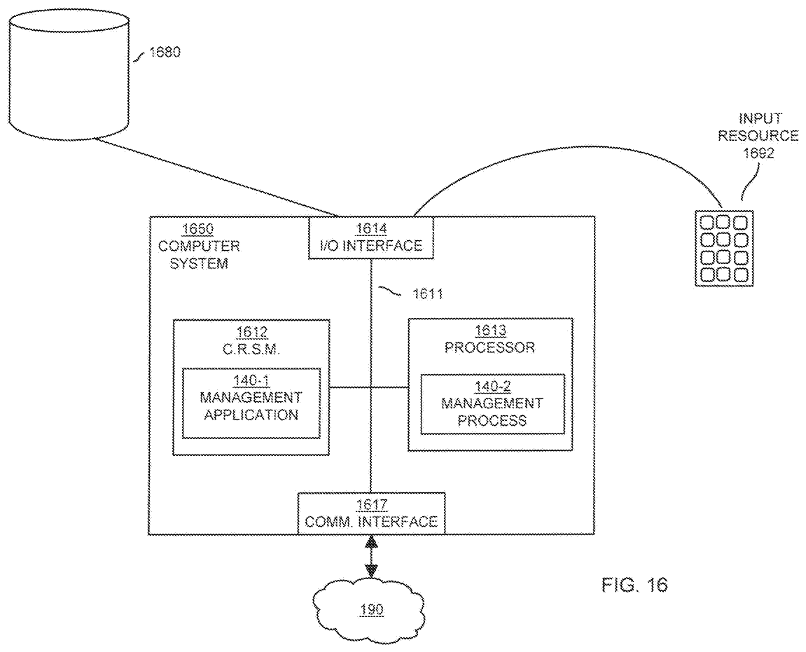

FIG. 16 is an example block diagram of a computer system for implementing any of the operations as previously discussed according to embodiments herein.

Any of the resources (such as communication management resource, wireless base stations, user equipment, etc.) as discussed herein can be configured to include computer processor hardware and/or corresponding executable instructions to carry out the different operations as discussed herein.

As shown, computer system 1650 of the present example includes interconnect 1611 coupling computer readable storage media 1612 such as a non-transitory type of media (which can be any suitable type of hardware storage medium in which digital information can be stored and or retrieved), a processor 1613 (computer processor hardware), I/O interface 1614, and a communications interface 1617.

I/O interface(s) 1614 supports connectivity to repository 1680 and input resource 1692.

Computer readable storage medium 1612 can be any hardware storage device such as memory, optical storage, hard drive, floppy disk, etc. In one embodiment, the computer readable storage medium 1612 stores instructions and/or data.

As shown, computer readable storage media 1612 can be encoded with communication management application 140-1 (e.g., including instructions) in a respective wireless station to carry out any of the operations as discussed herein.

During operation of one embodiment, processor 1613 accesses computer readable storage media 1612 via the use of interconnect 1611 in order to launch, run, execute, interpret or otherwise perform the instructions in communication management application 140-1 stored on computer readable storage medium 1612. Execution of the communication management application 140-1 produces communication management process 140-2 to carry out any of the operations and/or processes as discussed herein.

Those skilled in the art will understand that the computer system 1650 can include other processes and/or software and hardware components, such as an operating system that controls allocation and use of hardware resources to execute communication management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1650 may reside at any location or can be included in any suitable resource in any network environment to implement functionality as discussed herein.

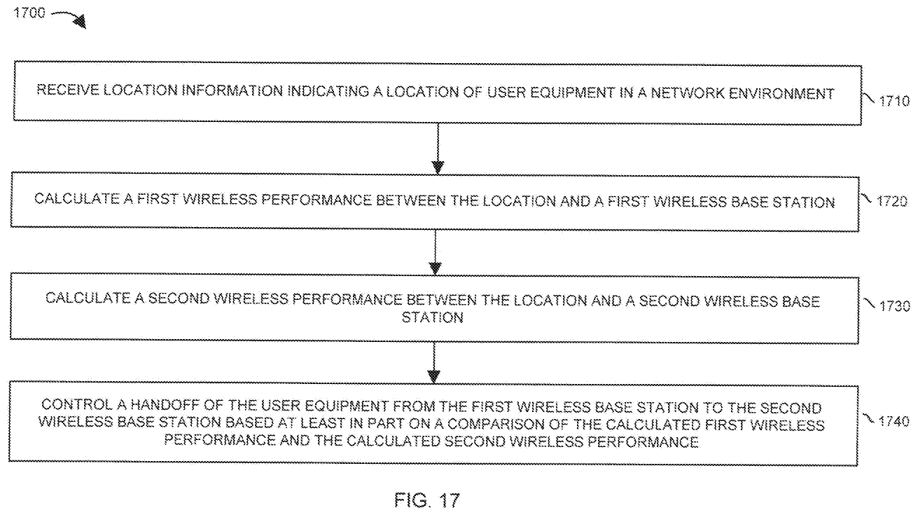

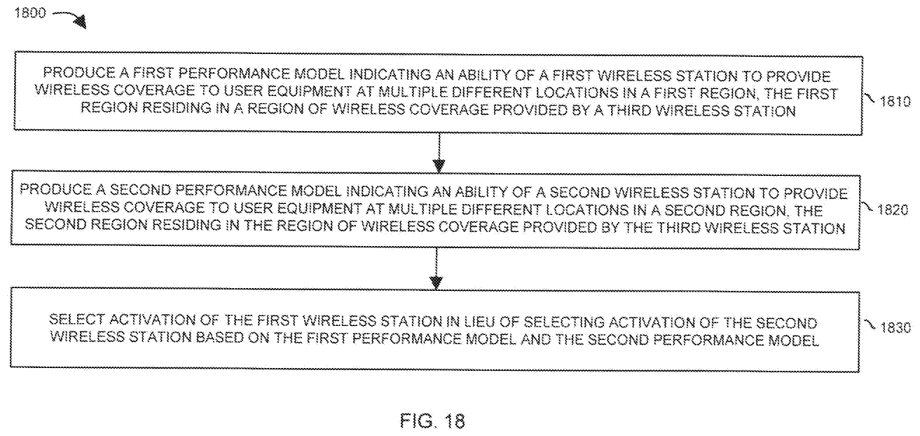

Functionality supported by the different resources will now be discussed via flowcharts in FIGS. 17 and 18. Note that the steps in the flowcharts below can be executed in any suitable order.

FIG. 17 is a flowchart 1700 illustrating an example method according to embodiments herein. Note that there will be some overlap with respect to concepts as discussed above.

In processing operation 1710, the communication management resource 1023 receives location information indicating a location of user equipment 910 in network environment 100.

In processing operation 1720, the communication management resource 1023 calculates a first wireless performance between the location and a first wireless base station (such as wireless base station 921).

In processing operation 1730, the communication management resource 1023 calculates a second wireless performance between the location and a second wireless base station (such as wireless base station 922).

In processing operation 1740, the communication management resource 1023 controls a handoff of the user equipment 910 from the first wireless base station 921 to the second wireless base station 922 based at least in part on a comparison of the calculated first wireless performance and the calculated second wireless performance.

FIG. 18 is a flowchart 1800 illustrating an example method according to embodiments herein. Note that there will be some overlap with respect to concepts as discussed above.

In processing operation 1810, the communication management resource 1340 produces a first performance model 911 indicating an ability of a first wireless station 1312 to provide wireless coverage (connectivity) to user equipment at each of multiple different grid locations in a first region 1332. The first region 1332 resides in a region of wireless coverage 1331 provided by a third wireless station 1311.

In processing operation 1820, the communication management resource 1340 produces a second performance model 912 indicating an ability of a second wireless station 1313 to provide wireless coverage to user equipment at each of multiple different grid locations in a second region 1333. The second region 1333 resides in the region of wireless coverage 1331 provided by the third wireless station 1311.

In processing operation 1830, the communication management resource 1340 selects activation of the first wireless station 1312 in lieu of selecting activation of the second wireless station 1313 based on the first performance model 911 and the second performance model 912.

Note again that techniques herein are well suited to facilitate improved use of wireless resources and corresponding wireless connectivity in a wireless network environment. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
receiving location information indicating a location of user equipment in a network environment;
calculating a first wireless performance between the location and a first wireless base station;
calculating a second wireless performance between the location and a second wireless base station; and
controlling a handoff of the user equipment from the first wireless base station to the second wireless base station based at least in part on a comparison of the calculated first wireless performance and the calculated second wireless performance.

2. The method as in claim 1, wherein the first wireless base station is a small cell base station;
wherein the second wireless base station is a large cell base station; and
wherein a region of wireless coverage provided by the first wireless base station resides within a region of wireless coverage of the second wireless base station.

3. The method of claim 1, wherein the user equipment is a subscriber device adapted for wireless communication with either the first wireless base station or the second wireless base station, the method further comprising:
computing a loading factor of the first wireless base station;
computing a loading factor of the second wireless base station, the loading factor indicative of a number of subscriber devices in wireless communication with the respective wireless base station in view of a maximum number of subscriber devices that can be in communication with the wireless base station; and
controlling the handoff based on the loading factor and the performance comparison.

4. The method of claim 3 further comprising identifying a wireless connection to the subscriber device as a candidate for a handoff;
determining that a performance improvement resulting from the handoff outweighs the increase in loading factor imposed by the handoff; and
performing the handoff based on the determination.

5. The method of claim 1 further comprising defining, for each of the first wireless base station and the second wireless base station, a performance model, the performance model indicative of, for each of a plurality of locations in a coverage area of each of the first wireless base station and the second wireless base station, the wireless performance from each location of the plurality of locations to the first wireless base station and the second wireless base station.

6. The method of claim 2, further comprising:
computing a performance model for the wireless coverage region around at least one of the wireless base stations, the performance model indicative of the wireless performance between the user equipment and a respective wireless base station, the performance model identifying:
a location of a connected subscriber device within the wireless coverage region;
the location of the base station centered within the coverage region; and
intervening obstacles between the location of the connected subscriber device and the location of the base station.

7. The method of claim 6 wherein the obstacles include man-made structures and geographic impositions.

8. The method of claim 6 further comprising:
maintaining the computed performance model based on a plurality of actual locations of subscriber devices and a corresponding wireless performance from each location of the plurality of actual locations.

9. The method of claim 6 further comprising:
maintaining the computed performance model as a grid representation of performance representative of an array of grid elements subdividing the wireless coverage area.

10. The method of claim 6 wherein computing the performance model includes:
subdividing the coverage region from a small cell into a grid arrangement defining location elements;
computing an initial performance estimation for each location element of the grid arrangement; and
generating a performance model of locations in the small call based on actual measured performance experienced by subscriber equipment at a location in the service area.

11. The method of claim 1 wherein calculating the first and second wireless performance further includes:
transmitting a sounding reference signal from each of the first wireless base station and second wireless base station; and
identifying, based on the sounding reference signal, which of the first wireless base station and second wireless base station incurs the least performance in communication with the user equipment.

12. The method of claim 1 further comprising:
establishing a transmission power level of the second wireless base station for covering a macro cell region;
establishing a transmission power level of the first wireless base station for covering a small cell region, at a lower transmission power level than the first base station, the small cell wireless coverage region within the wireless coverage region of the macro cell.

13. The method of claim 12 further comprising setting the transmission power level of the small cell region below a threshold that causes interference with users connected to the second wireless base station in the macro cell region in which the small cell is located.

14. The method of claim 12 further comprising adjusting the transmission power level of the wireless base station serving the small cell based on a size of the wireless coverage region of the small cell and interference within the wireless coverage region of the small cell.

15. The method of claim 12 further comprising reducing the transmission power of the wireless base station serving the small cell for reducing a coverage area in response to a reduced load at a corresponding macro cell region.

16. The method of claim 1 further comprising:
determining the wireless performance on an uplink to each of the first wireless base station and the second wireless base station;
using a performance model derived from prior communications of users communicating with the first wireless base station and the second wireless base station, concluding a lower performance on the uplink to the first wireless base station; and
establishing a wireless connection to the first wireless base station for uplink traffic and a connection to the second wireless base station for downlink traffic.

17. The method of claim 9 further comprising computing an initial performance estimate from a Sounding Reference Signal (SRS) and Channel State Information (CSI) for each element of the grid.

18. A system comprising:
an interface to a first wireless base station;
an interface to a second wireless base station;
a performance calculation machine (PCM) operative to determine a first wireless performance between a location of user equipment and a first wireless base station and for calculating a second wireless performance between the location of the user equipment and a second wireless base station; and
a mobility management entity (MME) for controlling a handoff of the user equipment from the first wireless base station to the second wireless base station based at least in part on a comparison of the calculated first wireless performance and the calculated second wireless performance.

19. The system as in claim 18, wherein the first wireless base station is a small cell base station;
wherein the second wireless base station is a large cell base station; and
wherein a region of wireless coverage provided by the first wireless base station resides within a region of wireless coverage of the second wireless base station.

20. The system as in claim 18 wherein the user equipment is a subscriber device adapted for wireless communication with either the first wireless base station or the second wireless base station, wherein the mobility management entity is operable to:
compute a loading factor of the first wireless base station;
compute a loading factor of the second wireless base station, the loading factor indicative of a number of subscriber devices in wireless communication with the respective wireless base station in view of a maximum number of subscriber devices that can be in communication with the wireless base station; and
control the handoff based on the loading factor and the performance comparison.

21. The system of claim 20 wherein the MME is operable to:
identify a wireless connection to the subscriber device as a candidate for a handoff; and
determine that a performance improvement resulting from the handoff outweighs the increase in loading factor imposed by the handoff; and
perform the handoff based on the determination.

22. The system of claim 18 further comprising:
a performance model, the performance model indicative of, for each of a plurality of locations in a coverage area of each of the first wireless base station and the second wireless base station, a respective wireless performance from each location of the plurality of locations to the first wireless base station, and a corresponding wireless performance from each location of the plurality of locations to the second wireless base station.

23. The system of claim 18, wherein the PCM is operable to compute a performance model for the region of wireless coverage around each of the first wireless base station and the second wireless base station, the performance model indicative of the wireless performance between the user equipment and a respective wireless base station, the performance model indicating:
a location of a connected subscriber device within the wireless coverage region;
the location of the base station centered within the coverage region; and
intervening obstacles between the location of the connected subscriber device and the location of the base station.

24. A system comprising:
a first wireless base station;
a second wireless base station; and
communication management hardware operative to:
receive location information indicating a location of user equipment in a network environment;
determine, via a first performance model associated with the first wireless base station, a first wireless communication performance level provided by the first wireless base station at the location of the user equipment;
via a second performance model associated with the second wireless base station, a second wireless communication performance level provided by the second wireless base station at the location of the user equipment; and
control a handoff of the user equipment from the first wireless base station to the second wireless base station based at least in part on a comparison of the determined first wireless communication performance level and the determined second wireless communication performance level.

25. Computer-readable storage hardware having instructions stored thereon, the instructions, when carried out by computer processor hardware, cause the computer processor hardware to:
receive location information indicating a location of user equipment in a network environment;
calculate a first wireless performance between the user equipment and a first wireless base station;
calculate a second wireless performance between the user equipment and a second wireless base station; and
control a handoff of the user equipment from the first wireless base station to the second wireless base station based at least in part on a comparison of the calculated first wireless performance and the calculated second wireless performance.

26. The method as in claim 1 further comprising:
adjusting a wireless power transmit level of the second wireless base station to accommodate the handoff of the user equipment form the first wireless base station to the second wireless base station.

27. The method as in claim 1, wherein the first wireless base station is operated by a first wireless network service provider; and
wherein the first wireless base station is operated by a first wireless network service provider.

28. The method as in claim 27, wherein controlling the handoff incudes:
initiating the handoff of the user equipment from the first wireless base station to the second wireless base station via a communication management resource operated by a third wireless network service provider to which a user of the user equipment subscribes.

29. A method comprising:
producing a first performance model indicating an ability of a first wireless station to provide wireless coverage to user equipment at multiple different locations in a first region, the first region residing in a region of wireless coverage provided by a third wireless station;
producing a second performance model indicating an ability of a second wireless station to provide wireless coverage to user equipment at multiple different locations in a second region, the second region residing in the region of wireless coverage provided by the third wireless station; and
selecting activation of the first wireless station in lieu of selecting activation of the second wireless station based on the first performance model and the second performance model.

30. The method as in claim 29 further comprising:
receiving first locations of first mobile devices in wireless connectivity with the third wireless station;
receiving second locations of second mobile devices in wireless connectivity with the third wireless station;
via the first performance model, determining an expected performance ability of the first wireless station to provide wireless connectivity to the first mobile devices at the first locations via the first performance model;
via the second performance model, determining an expected performance ability of the second wireless station to provide wireless connectivity to the second mobile devices at the second locations via the second performance model; and
wherein selecting the activation includes: selecting activation of the first wireless station in lieu of selecting activation of the second wireless station in response to detecting that the expected performance ability of the first wireless station to provide wireless connectivity to the first mobile devices at the first locations is greater than the expected performance ability of the second wireless station to provide wireless connectivity to the second mobile devices at the second locations.

31. The method as in claim 29 further comprising:
subsequent to activating the first wireless station, initiating a handoff of a set of mobile communication devices in communication with the third wireless station to the first wireless station.

32. The method as in claim 29 further comprising:
controlling a size of the wireless coverage provided by the first wireless station region depending on interference with the third wireless station.

33. The method as in claim 29 further comprising:
deactivating the first wireless station in response to detecting that a load of wireless mobile communication devices supported by the first wireless station falls below a threshold value.
